(19) United States
(12) Patent Application Publication
(10) Pub. No.: US 2004/0244601 A1
(43) Pub. Date: Dec. 9, 2004

(54) Bread maker and method of controlling the same

(75) Inventors: Jae-ryong Park, Suwon-city (KR); Yong-hyun Kwon, Suwon-city (KR); Chul Kim, Anyang-city (KR); Tae-uk Lee, Suwon-city (KR); Han-jun Sung, Suwon-city (KR); Jang-woo Lee, Suwon-city (KR); Dong-bin Lim, Suwon-city (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/805,350

(22) Filed: Mar. 22, 2004

(30) Foreign Application Priority Data
May 7, 2003 (KR) 2003-29065

(51) Int. Cl. A23L 1/00

(52) U.S. Cl. 99/348

(57) ABSTRACT

A bread maker having a main body having an oven compartment, a pair of parallel kneading drums spaced apart from each other inside the oven compartment and winding a mixing bag filled with ingredients to make bread thereon, and a drum driver driving the kneading drums to rotate, includes a rotation sensing part to sense rotated position of at least one of the kneading drums; and a controller to control the drum driver to decrease rotation torque of the kneading drum at a predetermined position before approaching a turning position of the kneading drum on the basis of the rotated position sensed by the rotation sensing part so as to approach the kneading drum slowly to the turning position. With this configuration, the present invention provides a bread maker and a method of controlling the same, which prevents a mixing bag from separating from a kneading drum due to excessive rotation of the kneading drums.

### CROSS-REFERENCE TO RELATED APPLICATIONS

This application claims the benefit of Korean Patent Application No. 2003-29065, filed May 7, 2003, in the Korean Intellectual Property Office, the disclosure of which is incorporated herein by reference.

### BACKGROUND OF THE INVENTION

1. Field of the Invention

The present invention relates to a bread maker and a method of controlling the same, and more particularly, to a bread maker and a method of controlling the same, which prevents a breakaway of a mixing bag from kneading drums inside the bread maker by controlling the kneading drums so that the kneading drums rotate slowly at a predetermined position before approaching turning positions of the kneading drums by decreasing rotation torque of the kneading drums based upon a sensed rotated position.

2. Description of the Related Art

Generally, a bread maker automatically performs kneading, leavening, and baking of bread dough, and provides fresh bread to a user, so that a user only needs to put ingredients in the bread maker. For example, a bread maker disclosed in Korean Patent First Publication No. 1988-7000638 includes a pair of parallel kneading drums at upper and lower parts of an oven compartment that reverse rotary direction periodically, a baking tray between the pair of kneading drums, a heater heating the inside of the oven compartment, a bar code reader, etc.

In the bread maker, upper and lower ends of a mixing bag filled with flour, water, etc., are attached to the upper and lower kneading drums, and then the mixing bag is reciprocated up and down over a predetermined period of time, thereby kneading the dough in the mixing bag.

After completing the kneading of the dough, the mixing bag is automatically separated from the upper kneading drum, and wound on the lower kneading drum, with the dough being squeezed out of the mixing bag and into the baking tray. Thereafter, the heater heats the inside of the oven compartment, thereby leavening and baking the dough during a predetermined period of time.

However, there is a problem in that during the bread making process, one or both of the upper and lower kneading drums may be rotated too far such that the mixing bag is wound beyond a safe distance. This presents a risk that the mixing bag will break and either not produce optimum quality bread or possibly spill the contents of the mixing bag. Such an incident would result in the need to thoroughly clean the interior of the bread maker and requires a significant amount of labor and potential for injury.

### SUMMARY OF THE INVENTION

Accordingly, it is an aspect of the present invention to provide a bread maker and a method of controlling the same, which prevents a breakaway of a mixing bag from kneading drums inside the bread maker by controlling the kneading drum to rotate slowly at a predetermined position before approaching a turning position of the kneading drum by decreasing rotation torque of the kneading drum based upon a sensed rotated position.

Additional and/or other aspects and advantages of the invention will be set forth in part in the description which follows and, in part, will be obvious form the description, or may be learned by practice of the invention.

### BRIEF DESCRIPTION OF THE DRAWINGS

These and/or other aspects and advantages of the present invention will become apparent and more readily appreciated from the following description of the embodiments, taken in conjunction with the accompany drawings of which:

FIG. 1 is a perspective view of a bread maker according to an embodiment of the present invention;

FIG. 2 is a cut open perspective view of a component compartment of FIG. 1;

FIG. 3 is a control block diagram of the bread maker according to an embodiment of the present invention;

FIG. 4 is a control flowchart of the bread maker according to an embodiment of the present invention;

FIG. 5 illustrates pulse signals output from the rotation sensing part; and

FIG. 6 is a control flow chart of the bread maker according to the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below in order to explain the present invention by referring to the figures.

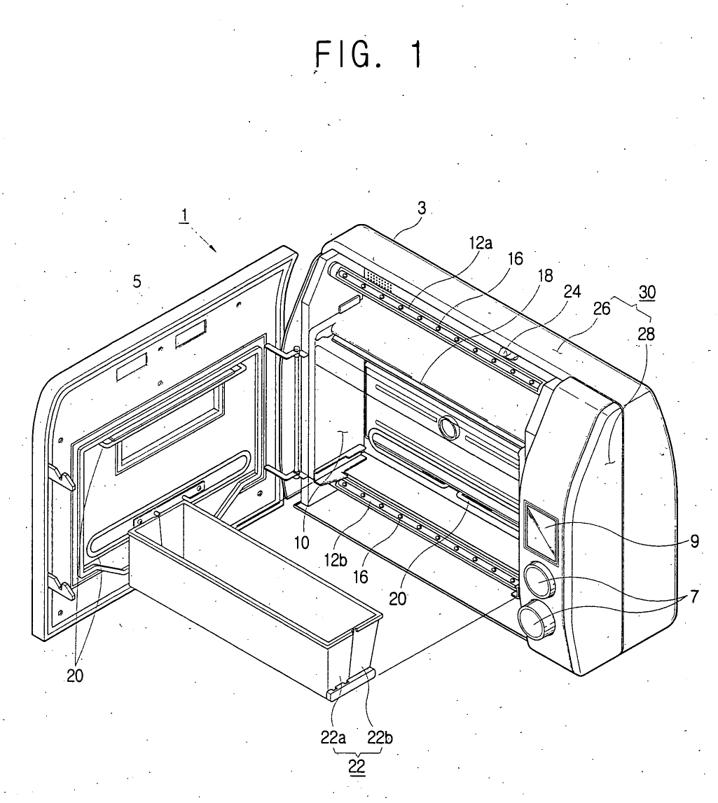

As shown in FIG. 1, a bread maker 1 according to the present invention comprises a main body 3 having an oven compartment 10 and a component compartment 30, a door 5 provided in the front of the main body 1 to open and close a front opening of the oven compartment 10, an operation selecting part 7 provided in a front side of the main body 3 and allowing a user to select an operation of the bread maker 1, and a display part 9 displaying an operating state of the bread maker 1.

In upper and lower parts of the oven compartment 10 are provided an upper kneading drum 12a and a lower kneading drum 12b, which are disposed in parallel and alternate clockwise and counterclockwise rotations. On the upper and lower kneading drums 12a and 12b are wound opposite ends of a mixing bag (not shown) filled with ingredients to make the bread, respectively. Each kneading drum 12a and 12b has a plurality of holding projections 16 protruding along a lengthwise direction thereof to hold the opposite ends of a mixing bag, so that the mixing bag can be attached to the kneading drums 12a and 12b.

In a lower part of the oven compartment 10, there is a baking tray 22 in which the kneaded dough is baked between the upper and lower kneading drums 12a and 12b. The baking tray 22 includes a first tray 22a and a second tray 22b, each having an “L”-shaped section symmetrical to one another that combine into a box shape having an open top.

In an upper part of the oven compartment 10, a pair of dough-blocking members 18 is provided between the upper kneading drum 12a and the baking tray 12b to knead the dough contained in the mixing bag within the baking tray 22, preventing the dough from moving outside the baking tray 22.

At upper and lower parts of the inside walls of the oven compartment 10 and the door 5 are provided heaters 20 to heat the inside of the oven compartment 10.

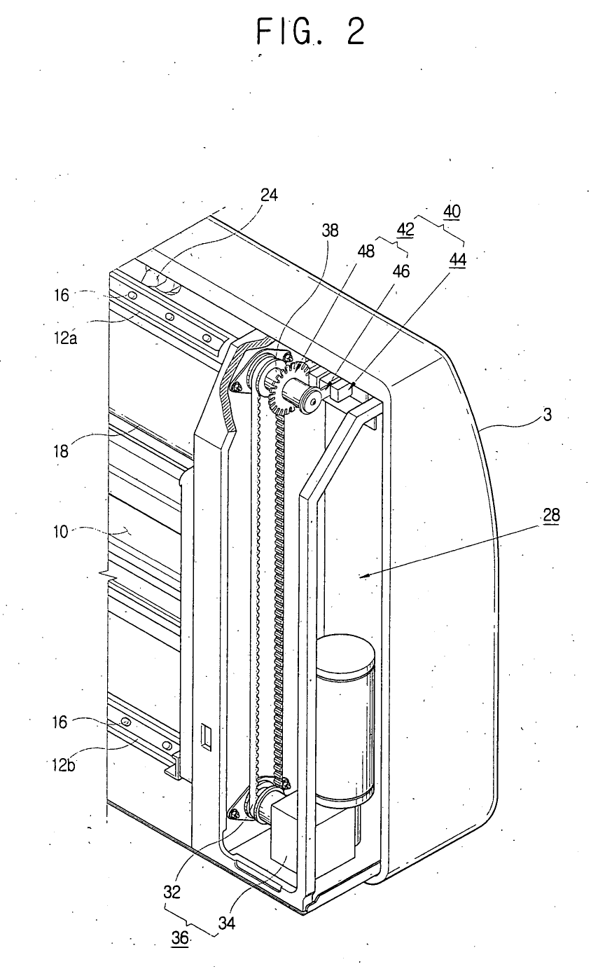

The component compartment 30 includes a first component compartment 28 placed beside the oven compartment 10 and a second component compartment 26 placed behind the oven compartment 10. As shown in FIG. 2, inside the first component compartment 28 is provided a drum driver 36 that rotates the upper and lower kneading drums 12a and 12b in clockwise and counterclockwise directions. Inside the second component compartment 26 is provided a bar code reader 24 that reads a bar code printed on or applied to the mixing bag that is wound on the upper and lower kneading drums 12a and 12b.

The drum driver 36 includes a motor 34 that rotates the lower kneading drum 12b, and a belt 32 that transmits a rotary movement of the lower kneading drum 13 to a rotation shaft 38 of the upper kneading drum 12a. The bar code reader 24 may move near to, and distantly from, an outer circumference of the upper kneading drum 12b.

On the other hand, the bread maker 1, according to an embodiment of the present invention, comprises a rotation sensing part 40 to sense rotation of at least one of the upper and lower kneading drums 12a and 12b.

The rotation sensing part 40 includes a disk part 42 attached to the rotation shaft 38 of the upper kneading drum 12a, and a rotation sensor 44 placed near the disk part 42 that outputs a pulse signal by sensing the rotation of the disk part 42.

The disk part 42 includes a first disk 46 that allows the rotation sensor 44 to sense one revolution of the upper kneading drum 12a, and a second disk 48 that allows the rotation sensor 44 to sense a rotation of the upper kneading drum 12a that is less than one complete turn.

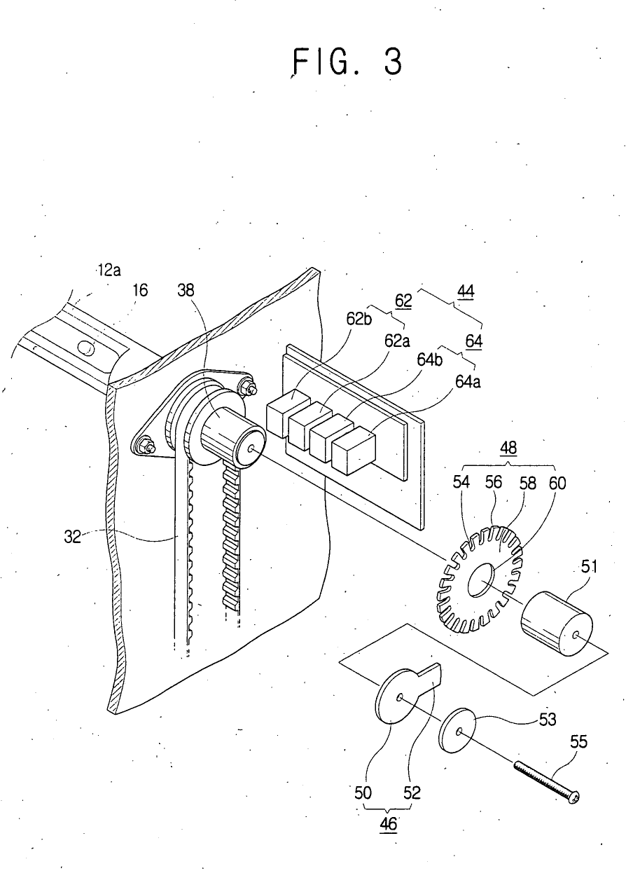

Hereinbelow, these components of the rotation sensing part 40 will be described in more detail with reference to FIG. 3.

The first disk 46 is a circular plate 50, which is separated from the second disk 48 by a cylindrical part 51 and connected to the rotation shaft 38 of the upper kneading drum 12a using a washer 53 and a bolt 55. The circular plate 50 is formed with a single projection 52 radially extended therefrom. Hence, the first disk 46 rotates with the upper kneading drum 12a and allows the rotation sensor 44 to sense one revolution of the upper kneading drum 12a.

The second disk 48 is a circular plate 58 with a shaft combining hole 60 used to attach the circular plate 58 to the rotation shaft 38 of the upper kneading drum 12a. The circular plate 58 has a plurality of slots 54 along the circumference thereof at regular intervals, forming a plurality of projections 56. For example, in the embodiment shown in FIG. 3, the second disk 48 has twenty-four slots 54, forming twenty-four projections 56. Hence, the second disk 48 rotates with the upper kneading drum 12a and allows the rotation sensor 44 to sense a rotation of the upper kneading drum 12a that is less than one revolution.

The rotation sensor 44 includes a first disk sensor 64 sensing the single projection 52 of the first disk 46 and outputting one pulse signal per revolution of the upper kneading drum 12a, and a second disk sensor 62 sensing the twenty-four projections 56 of the second disk 48 and outputting twenty-four pulse signals per revolution of the upper kneading drum 12a. That is, while the upper kneading drum 12a makes one revolution, the first and second disk sensors 46 and 48 output one and twenty-four pulse signals, respectively.

The first and second disk sensors 64 and 62 are each used as a pulse generator, and include light emitting parts 64a and 62a that emit a sensing signal such as infrared rays toward the first and second disks 46 and 48, and light receiving parts 64b and 62b that face the light emitting parts 64a and 62a, respectively, across the first and second disks 46 and 48 and receive the light emitted from the light emitting parts 64a and 62a, respectively.

The first disk sensor 64 senses when the single projection 52 of the first disk 46 interrupts the light emitted from the light emitting part 64a to the light receiving part 64b, thereby outputting one pulse signal per one complete turn of the upper kneading drum 12a.

It is understood that the rotation sensing part 40 may also comprise a single rotation disc as a circular shaped member and having convex sections and concave sections in the circumference, and a rotation signal sensor having a radiating part and a signal sensing part provided in parallel with the rotation disc interposed therebetween.

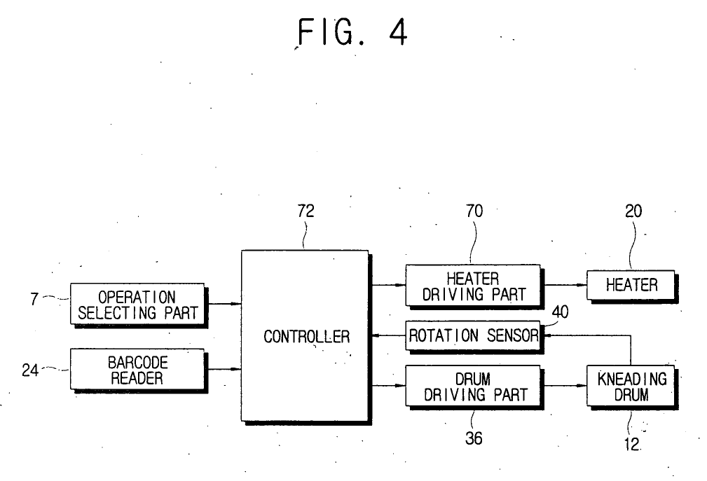

FIG. 4 is a control block diagram of the bread maker according to an embodiment of the present invention. As shown therein, when a user selects a bar code reading operation through the operation selecting part 7, a controller 72 of the bread maker 1 controls the drum driver 36 to turn on the motor 34 to partially wind the mixing bag attached to the kneading drums 12a or 12b on the kneading drum 12a or 12b. As the mixing bag is wound on the kneading drum 12a or 12b, the bar code reader 24 reads the bar code printed or applied on the mixing bag.

On the basis of the bar code, including information on kneading time, leavening time, leavening temperature, baking time, baking temperature, etc., of a particular recipe, which is read by the bar code reader 24, the controller 72 controls the drum driver 36 to rotate the kneading drums 12 so as to knead the dough contained in the mixing bag, and controls a heater driving part 70 to turn on the heaters 20 so as to leaven and bake the dough.

The rotation sensor 44 transmits the pulse signals output from the first and second disk sensors 62 and 62 to the controller 72, and then the controller 72 determines a rotated position of the upper kneading drum 12a based upon the output pulse signals, and controls the motor 34 of the drum driver 36 to reverse a rotating direction of the upper and lower kneading drums 12a and 12b, thereby adjusting a reciprocating distance of the mixing bag.

Here, the controller 72 controls an on/off cycle of a switching element (not shown) provided in the drum driver 36 so as to lower a PWM (pulse width modulation) duty of the motor 34 when the kneading drum 12 is in a predetermined position before approaching a turning position, thereby decreasing rotation torque of the kneading drum 12. Thus, the kneading drums 12 are slowly rotated toward the turning position by the decreased rotation torque and a load of the ingredients contained in the mixing bag. When the kneading drums 12 are in the turning position, the rotating direction of the motor 34 is reversed, thereby reciprocating the mixing bag up and down.

However, in the case where the load of the ingredients contained in the mixing bag is relatively slight, the kneading drum 12 may excessively rotate more than the turning position. At this time, the controller 72 determines whether the kneading drum 12 is excessively rotated or not on the basis of the rotated position sensed by the rotation sensing part 40. Further, when the kneading drum 12 is in a predetermined position before approaching a mixing bag breakaway position, the controller 72 controls two terminals of the motor 34 to be shorted, thereby braking the motor 34. Thus, the kneading drums 12 are prevented from rotating over the mixing bag breakaway position due to the excessive rotation, thereby preventing the mixing bag from separating from the kneading drums 12.

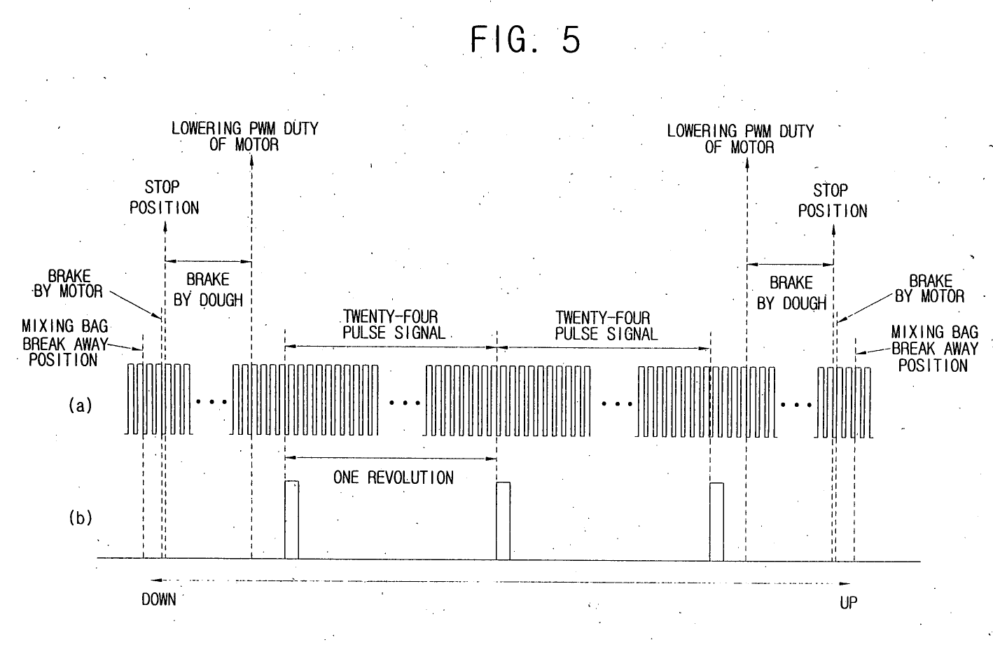

FIG. 5 illustrates the pulse signals output from the first and second disk sensors 64 and 62. As shown therein, while the upper kneading drum 12a rotates, the first and second disk sensors 64 and 62 output pulse signals by sensing the rotation of the first and second disks 46 and 48, respectively. Because the first and second disks 46 and 48 are formed with the single and twenty-four projections 52 and 56, respectively, the first disk sensor 64 outputs one pulse signal (sequence “b”) while the second disk sensor 62 outputs twenty-four pulse signals (sequence “a”).

The kneading operation is performed by rotating the kneading drums 12 to wind the mixing bag on the kneading drums 12 alternately. At this time, the controller 72 controls the PWM duty of the motor 34 of the drum driver 36 to be lowered at the pulse signal which precedes the pulse signal of the clockwise turning position or the counterclockwise turning position of the kneading drums 12 by a predetermined number, thereby stopping the kneading drums 12 at the turning position by the decreased rotation torque and the load of the ingredients contained in the mixing bag. Nevertheless, if the kneading drums 12 are not stopped at the turning position and are rotated over the turning point, the motor 34 is braked at the pulse signal which precedes the pulse signal of the mixing bag breakaway position of the kneading drums 12 by a predetermined number.

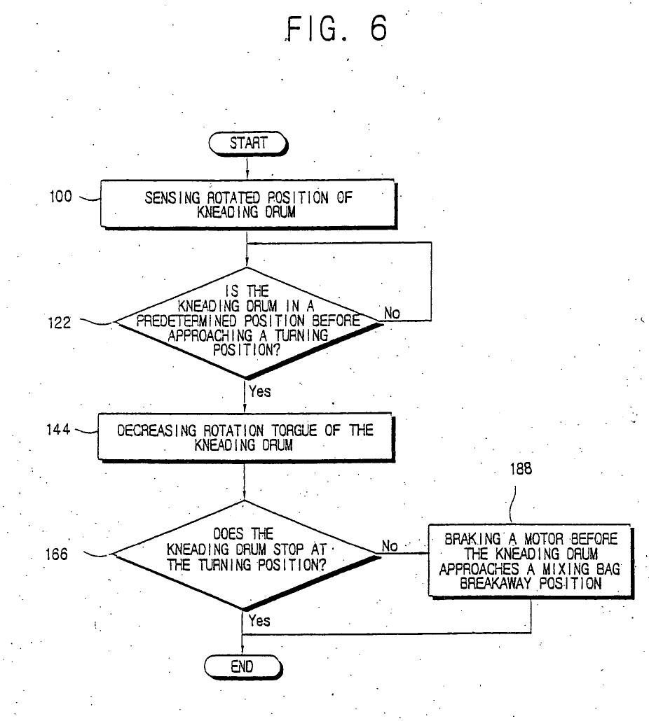

With this configuration, operation of the bread maker 1 will be described with reference to FIG. 6. At operation 100, while the kneading drum 12 rotates, the rotation sensing part 40 senses the rotated position of the kneading drum 12. At operation 122, the controller 72 determines whether or not the kneading drum 12 is in a predetermined position before approaching the turning position based upon the output pulse signals. At operation 144, when the kneading drum 12 is in the position before approaching the turning position, the PWM duty of the motor 34 of the drum driver 36 is lowered, thereby decreasing the rotation torque of the kneading drum 12. At operation 166, the controller 72 determines whether or not the kneading drums 12 stop at the turning position by the decreased rotation torque and the load of the ingredients contained in the mixing bag. At operation 188, when the kneading drums 12 are not stopped at the turning position and are rotated over the turning position, two terminals of the motor 34 are shorted before approaching the mixing bag breakaway position, thereby braking the motor 34.

As described above, the kneading drums are slowly rotated at a predetermined position before approaching the turning position by lowering the PWM duty of the motor. Further, the kneading drums stop at the turning position by the decreased rotation torque and the load of the ingredients contained in the mixing bag, thereby preventing the mixing bag from separating from the kneading drum due to the excessive rotation of the kneading drums.

As described above, the present invention provides a bread maker and a method of controlling the same, which prevents a mixing bag from separating from a kneading drum due to excessive rotation of the kneading drums.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A bread maker having a main body having an oven compartment, a pair of parallel kneading drums spaced apart from each other inside the oven compartment and winding a mixing bag filled with ingredients to make bread thereon, and a drum driver driving the kneading drums to rotate, comprising:
a rotation sensing part sensing rotation of at least one of the kneading drums; and
a controller controlling the drum driver and thereby rotating the at least one kneading drum slowly, at a predetermined position before approaching a turning position of the at least one kneading drum based on the rotated position sensed by the rotation sensing part, by decreasing rotation torque of the at least one kneading drum.

2. The bread maker according to claim 1, wherein when the controller determines that the kneading drum is rotated over the turning position based on the rotated position sensed by the rotation sensing part, the controller controls the drum driver to drive the kneading drum to stop at a predetermined position before approaching a mixing bag breakaway position, at which the mixing bag is separated from the kneading drum.

3. A method of controlling a bread maker having a main body having an oven compartment, a pair of kneading drums spaced apart from each other inside the oven compartment and winding a mixing bag filled with ingredients to make bread thereon, and a drum driver driving the kneading drums to rotate, comprising:
sensing rotation of at least one of the kneading drums; and
controlling the drum driver and thereby rotating the at least one kneading drum slowly, at a predetermined position before approaching a turning position of the at least one kneading drum based on the rotated position sensed by the rotation sensing part, by decreasing rotation torque of the at least one kneading drum.

4. The method according to claim 3, further comprising controlling the drum driver to drive the kneading drum to stop at a predetermined position before approaching a mixing bag breakaway position, at which the mixing bag is separated from the kneading drum, when the kneading drum is determined to be rotated over the turning position based on the rotated position sensed by the rotation sensing part.

5. A bread maker to make bread from ingredients contained in a mixing bag, comprising:
an oven compartment in which a bread making process is performed, including a kneading drum, having a holder which holds the mixing bag, rotating and thereby knead the bread;
a drum driver transmitting a rotational force to the kneading drum;
a rotation sensing part sensing rotation of the kneading drum; and
a controller controlling the drum driver and thereby rotating the kneading drum at a decreased rate of rotation, when the kneading drum is determined to be at a predetermined position, based on the rotated position sensed by the rotation sensing part, before approaching a turning position, by decreasing a rotation torque of the kneading drum.

6. The bread maker according to claim 5, wherein the kneading drum of the oven compartment is plural in number and located in upper and lower portions of the oven compartment, respectively.

7. The bread maker according to claim 6, wherein the upper and lower kneading drums are spaced apart form each other and are provided in parallel.

8. The bread maker according to claim 7, further comprising a baking tray in which kneaded dough is baked, wherein the baking tray comprises
a first tray and a second tray, each tray having an L-shaped symmetrical section facing the other thereby forming a box with an open top.

9. The bread maker according to claim 8, further comprising a pair of dough blocking members between the upper kneading drum and the baking tray to prevent ingredients from moving outside the baking tray.

10. The bread maker according to claim 5, further comprising heaters to heat the ingredients in the mixing bag.

11. The bread maker according to claim 5, further comprising first and second component compartments, wherein the drum driver is located in the first compartment and a bar code scanner is located in the second compartment.

12. The bread maker according to claim 11, wherein the bar code scanner reads a bar code on the mixing bag.

13. The bread maker according to claim 5, wherein the rotation sensing part comprises:
a disk part rotating in accordance with a rotation of the kneading drum; and
a rotation sensor outputting a signal by sensing the rotation of the disk part.

14. The bread maker according to claim 13, wherein the disk part comprises:
a first disk sensing one rotation of the kneading drum; and
a second disk sensing less than one rotation of the kneading drum.

15. The bread maker according to claim 14, wherein the first disk is a circular plate formed with a projection radially extended therefrom to a rotation sensor sensing area.

16. The bread maker according to claim 15, wherein the second disk is a circular plate having a plurality of slots extending therefrom to the rotation sensor sensing area along the circumference thereof at regular intervals.

17. The bread maker according to claim 14, wherein the rotation sensor comprises:
a first disk sensor sensing the first disk; and
a second disk sensor sensing the second disk.

18. The bread maker according to claim 17, wherein the first disk sensor and the second disk sensor comprise:
light emitting parts emitting a sensing signal, which penetrates the first and second disks, respectively; and
light receiving parts facing the light emitting parts across the first and second disks, respectively, and receiving the light emitting from the light emitting parts.

19. A method of controlling a bread maker in which a bread making process is carried out via a heater to heat ingredients contained in a mixing bag to be wound onto a kneading drum, comprising:
sensing a rotation position of the kneading drum;
determining whether the kneading drum is in a predetermined rotation position before approaching a turning position;
decreasing rotation torgue of the kneading drum if the kneading drum is in the predetermined rotation position;
determining if the kneading drum is stopped at the turning position; and
braking a motor before the kneading drum approaches a mixing bag breakaway position, if the kneading drum is not stopped at the turning position.

20. The method according to claim 19, further comprising winding the mixing bag onto the kneading drum.

21. The method according to claim 20, wherein the winding comprises reading a bar code on the mixing bag to determine the bread making process to be carried out.

22. The method according to claim 21, further comprising controlling the kneading drum and the heater to knead and heat the ingredients in the mixing bag.

23. The method according to claim 19, wherein the initial determining operation comprises transmitted pulse signals from a rotation sensor to a controller.

24. The method according to claim 23, further comprising reversing a rotating direction of the kneading drum based upon the transmitted pulse signals.

25. The method according to claim 24, further comprising controlling an on/off switching element to lower a pulse width modulation (PWM) duty of a motor when the kneading drum is in the predetermined position before approaching a turning position.
